(19) United States
(12) Patent Application Publication
(10) Pub. No.: US 2020/0184434 A1
(43) Pub. Date: Jun. 11, 2020

(54) SYSTEM AND METHOD FOR IDENTIFYING AND MANAGING GOODS AND SERVICES BASED ON DISUSE

(71) Applicant: Wells Fargo Bank, N.A., San Francisco, CA (US)

(72) Inventors: Christiane Evans, San Francisco, CA (US); Albert Hwu, San Francisco, CA (US); Chris Kalaboukis, San Jose, CA (US); Kristine Ing Kushner, Orinda, CA (US); Ashish B. Kurani, Hillsborough, CA (US); Nikolai Stroke, Gilbert, AZ (US); Raissa Williams, San Francisco, CA (US); Young M. Yang, San Francisco, CA (US)

(21) Appl. No.: 16/213,837

(22) Filed: Dec. 7, 2018

(51) Int. Cl. G06Q 20/10; G06Q 20/40; G06Q 20/14

(52) U.S. Cl. CPC G06Q 20/102; G06Q 20/14; G06Q 20/407

(57) ABSTRACT

A computing system includes one or more processors and one or more computer-readable storage media communicatively connected to the one or more processors and having instructions stored thereon that, when executed, causes the one or more processors to analyze a plurality of electronic payment transactions from an account associated with a user to identify payments to a merchant on a recurring basis, receive external data associated with the user corresponding to usage of a good or service provided by the merchant, analyze the external data to identify disuse of the good or service, generate a recommended action based on the disuse, present the recommended action on an interactive display on a user device associated with the user, and change a subscription associated with the good or service corresponding to the recommended action.

### BACKGROUND

The present disclosure relates generally to the field of systems and methods for automatically identifying subscription-based (or membership-based) goods and services that are in disuse (or not used) and automatically managing the subscription (or membership) based on the disuse.

With the advent of the Internet, subscription-based (or membership-based, collectively referred to as subscription-based hereinafter) goods and services have become increasingly popular. Subscription-based goods and services are those in which a customer or user makes payments to merchants of the goods and services at predetermined intervals (e.g., daily, monthly, bi-monthly, quarterly, yearly, and/or the like) in order to use or have access to the goods and services. Such goods and services can be appealing to users, since the users are generally allowed to cancel the subscription or membership (and hence, forego further payments) after some contractually agreed upon time has lapsed or when the goods or services are no longer needed or desired. However, users may forget to cancel the subscription (or membership), especially when recurring payments to the merchants are scheduled to automatically occur, which can lead to payments for goods or services that are no longer used. Further, merchants may exacerbate the problem by making it difficult or time consuming to cancel the subscription (or membership), since a large source of income for such subscription-based goods and services is generated from recurring payments received from the users regardless of whether the goods or services are being used. Thus, even if the user desires to cancel the subscription, the user may become frustrated with the cancellation process, which can cause delays or even forego cancellation even though the goods or services are disused.

Accordingly, systems and methods for automatically identifying goods and services that are disused (or not used) to enable efficient management of subscriptions (or memberships) associated with the goods and services may be desired.

### SUMMARY

One arrangement relates to a computing system that includes one or more processors and one or more computer-readable storage media communicatively coupled to the one or more processors and having instructions stored thereon that, when executed by the one or more processors, cause the one or more processors to analyze a plurality of electronic payment transactions from an account associated with a user to identify payments to a merchant on a recurring basis, receive external data associated with the user corresponding to usage of a good or service provided by the merchant, analyze the external data to identify disuse of the good or service, generate a recommended action based on the disuse, present the recommended action on an interactive display on a user device associated with the user, and change a subscription associated with the good or service corresponding to the recommended action.

One arrangement relates to a method including analyzing, by one or more processors of a computing system, a plurality of electronic payment transactions from an account associated with a user to identify payments to a merchant on a recurring basis, receiving, by the one or more processors, external data associated with the user corresponding to usage of a good or service provided by the merchant, analyzing, by the one or more processors, the external data to identify disuse of the good or service, generating, by the one or more processors, a recommended action based on the disuse, presenting, by the one or more processors, the recommended action on an interactive display on a user device associated with the user, and changing, by the one or more processors, a subscription associated with the good or service corresponding to the recommended action.

One arrangement relates to a non-transitory computer-readable medium having processor-readable instructions stored thereon such that, when executed by a processor, cause the processor to analyze a plurality of electronic payment transactions from an account associated with a user to identify payments to a merchant on a recurring basis, receive external data associated with the user corresponding to usage of a good or service provided by the merchant, analyze the external data to identify disuse of the good or service, generate a recommended action based on the disuse, present the recommended action on an interactive display on a user device associated with the user, the interactive display including one or more interactive elements to cancel, suspend, or modify a subscription associated with the good or service, receive user input corresponding to a selection of one of the one or more interactive elements; and change the subscription associated with the good or service in response to the user input.

### BRIEF DESCRIPTION OF THE DRAWINGS

The above and other aspects and features of the present disclosure will become more apparent to those skilled in the art from the following detailed description of the example arrangements with reference to the accompanying drawings, in which:

FIG. 1 is a block diagram of a system for managing goods or services that are disused, according to an example arrangement;

FIG. 2A is a diagram of an example of the user device of the system set forth in FIG. 1, according to some arrangements;

FIG. 2B is a diagram of an example of the provider computing system of the system set forth in FIG. 1, according to some arrangements;

FIGS. 3A through 3C show an interactive display for enabling a user to manage one or more subscription-based goods or services, according to some arrangements; and

FIG. 4 is a flow chart of a process of managing a subscription-based good or service based on disuse, according to some arrangements.

### DETAILED DESCRIPTION

One or more example arrangements described herein relate to systems, apparatuses, and methods for implementing Artificial Intelligence (AI) to automatically identify goods (e.g., products) or services that are disused, and to provide a recommended action based on the disuse. In some arrangements, the AI system automatically identifies a good or service that a user or customer does not appear to be using, and notifies the user or customer of the potentially disused good or service. In some arrangements, the AI system provides a recommendation to the user or customer to cancel (or end), suspend, or modify the subscription or membership corresponding to the disused good or service. As used in this specification, the terms “automatic” or “automatically” are defined as pertaining to an electronically carried out action that does not require outside (either human or machine) intervention to be scheduled, triggered, executed, and/or completed.

In general, the arrangements of the AI system described herein automate the effective management of subscription-based goods and services that has not been previously automated. The AI system described herein can identify subscription-based goods and services from recurring payments to merchants of the goods and services, and can detect disuse of the goods and services by analyzing external data received from the merchant and/or one or more applications installed on the user device to determine or infer disuse of the goods and services. For example, the AI system may receive usage data associated with the user directly from the merchant, and/or can analyze user data generated by the one or more applications installed on the user device to infer disuse. The systems and methods disclosed herein can be adapted to monitor customers' account information, historical transaction data, 3r^{d} party data, device data, and other data and activities to identify disuse and to generate one or more recommended actions to manage the subscription-based on the identified disuse.

In an example arrangement, the AI system includes a particular and unique set of rules, which are set up to account for and learn from the customer's activities that would have required human intervention. Additionally, another particular and unique set of rules define automated transaction processing, notifications, disuse identification, recommendation generation, electronic communications, and the like, which traditionally would have required an evaluation by a human being.

The arrangements of the AI system described herein improve computer-related technology by performing certain steps that cannot be done by conventional provider institution systems or human actors. For example, the AI system is configured to proactively determine potential subscription-based goods and services from recurring payments, identify disuse of the goods and services from externally generated data, notify in real-time or near real-time the customer of the recurring payment for a good or service that the customer does not appear to be using, generate one or more recommended actions to manage a subscription associated with the good or service that the customer does not appear to be using, and automatically changing the subscription to cancel, suspend, and/or modify the subscription. In some arrangements, to achieve benefits over conventional systems having databases, tables, and field definitions that are static, the databases described herein may be data-type agnostic and configured to store different information for different users, merchants, transaction types, and the like. Furthermore, to achieve benefits over conventional databases and to solve a technical problem of improving dimensional scalability (such that different aspects of transactions may be analyzed for different users on the same data storage infrastructure as an autonomous recurring payment but learns the relevant aspects through pattern mining and machine learning), and faster identification of the subscription-based goods and services by reducing computer processing times for analyzing transactions of customers and external data from multiple sources, the data stored in multidimensional form may be aggregated and/or stored using improved methods. For example, merchant information may be dynamically collected and/or adjusted after being stored when the data is retrieved for analysis and/or transaction processing.

In some arrangements, if the AI system identifies a potential subscription-based good or service that the user no longer appears to be using, the AI system sends a notification or otherwise notifies the customer of the potential waste for continuing to pay for such good or service. For example, the AI system may visually display (e.g., via an electronic user interface such as an interactive dashboard) or otherwise indicate on a user device associated with the customer, one or more such subscription-based good or service and one or more recommended actions based on the disuse. The system can then manage the subscription-based good or service with the merchant of the subscription-based good or service without further intervention from the user. Accordingly, arrangements described herein solve the technical problem of determining the appearance and functionality of an electronic user interface that allows for the efficient management of subscription-based goods and services that have not been previously automated. Further, arrangements described herein solve the internet-centric problem of automating data collection from merchant systems and user devices, and providing these services in a convenient manner (e.g., via an API or application installed on the user device to collect the data).

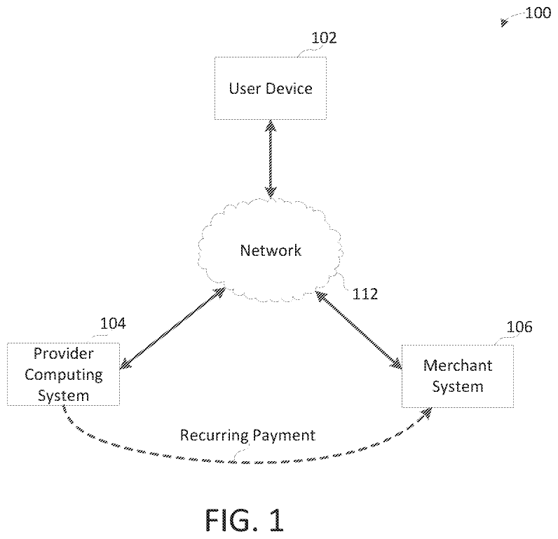

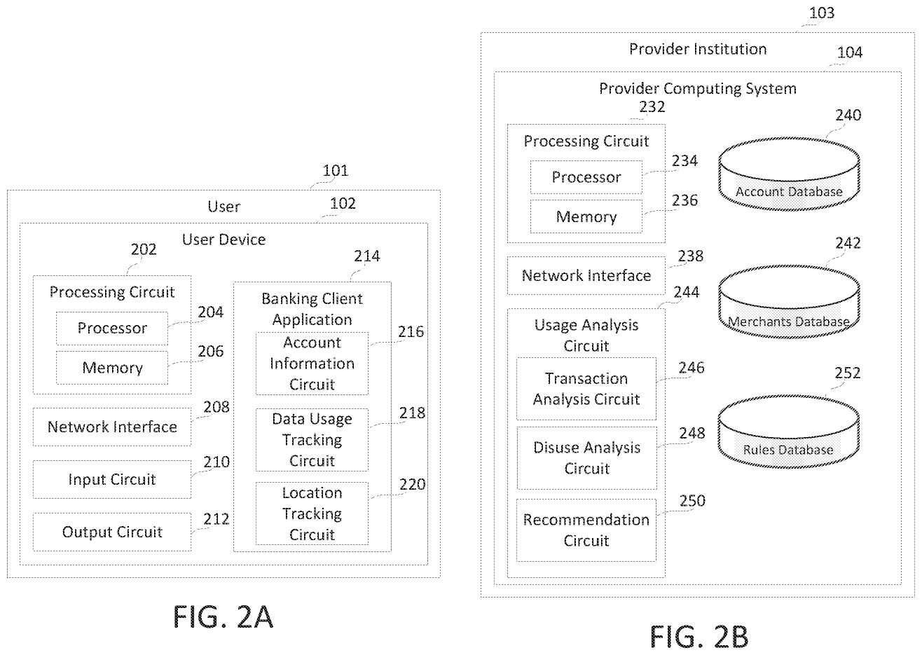

FIG. 1 is a diagram of an example of a system 100 for managing goods or services that are disused, according to an example arrangement. Referring to FIG. 1, a user (e.g., a customer) of a user device 102 is a customer of a provider institution associated with a provider computing system 104. The user of the user device 102 may be any suitable entity (e.g., an individual, a company, or the like). In some arrangements, the provider institution may be a financial institution. Accordingly, the user may have an account (e.g., checking account, savings account, credit account, mortgage account, and/or the like) established with the provider institution, and the provider institution may store information corresponding to the user. For example, the provider institution may store a profile corresponding to the user and account information corresponding to one or more accounts associated with the user in a data store (e.g., account database 240 in FIG. 2 or the like) accessible by the provider computing system 104. In some arrangements, the profile corresponding to the user may include information corresponding to the user, such as, for example, name, address, telephone number, business type, industry type, business hours, working days or non-working days, number of employees, net worth, assets, liabilities, and/or the like. In some arrangements, the account information corresponding to one or more accounts associated with the user may include information, such as, for example, account balance, purchase history, transaction history (e.g., credits and debits), payment history, scheduled payment information, recurring payment information, and/or the like.

In some arrangements, the provider institution can collect and store transactional information in the course of dealing (e.g., processing transactions, offering products/services, and the like) with the user and other customers of the provider institution. For example, the user may operate the user device 102 to initiate an electronic transaction with the provider computing system 104 to make a payment to a merchant associated with the merchant system 106. In another example, the user may operate the electronic device 102 to schedule a recurring electronic payment with the provider computing system 104 to make automatic recurring payments to the merchant associated with the merchant system 106 for each predetermined time period (e.g., daily, monthly, bi-monthly, quarterly, yearly, and/or the like). In still another example, the user may operate the electronic device 102 to schedule an electronic transaction (e.g., one time or recurring) with the merchant system 106 to request a payment (e.g., credit card payment, Automated Clearing House ACH transfer, or the like) from the provider computing system 104. The merchant may be any suitable entity (e.g., an individual, a company, or the like). The electronic transaction (e.g., one-time payment, recurring payments, and/or the like) may be processed by the provider computing system 104, and transactional information corresponding to the electronic transaction may be collected and stored. In some arrangements, the transactional information may include, for example, information corresponding to the merchant (e.g., name, account and routing number, location or address, industry or business, and/or the like), transaction type, amount of the transaction, date of the transaction, time of the transaction, and/or the like.

In some arrangements, the provider computing system 104 may communicate (e.g., via an application programming interface API or the like) with the merchant system 106 to collect or otherwise receive merchant data from the merchant system 106. The merchant data may include usage data corresponding to the user's usage of the merchant's goods or services. The merchant data may be used by the provider computing system 104 to identify disuse of a good or service provided by the merchant. For example, the provider computing system 104 may use the merchant data to determine if the user (or someone having access to the user's subscription or membership with the merchant) has recently used the good or service provided by the merchant. However, as discussed above, the merchant may be reluctant to provide the merchant data to the provider computing system 104, since collecting recurring payments for unused subscription services is a significant source of income for many subscription-based goods and services. In this case, in other arrangements, the provider computer system 104 may infer usage or disuse of a good or service by collecting and analyzing other available data (e.g., data provided by the user device 102, and/or the like).

In some arrangements, the provider computing system 104 may communicate (e.g., via API or the like) with the merchant system 106 to configure various options that the provider computing system 104 can provide as one or more recommended actions to the user. For example, in some arrangements, the merchant system 106 may provide configuration information (e.g., form attributes and parameters) to allow the provider computing system 104 to cancel (or end) a subscription or to temporarily suspend the subscription (and thus, to suspend or reduce a payment for the subscription) for a predetermined amount of time (e.g., one month). However, as discussed above, recurring payments of unused subscription services can be a significant source of income for many subscription-based goods or services, and thus, merchants may be reluctant to provide the configuration information to cancel or temporarily suspend the subscription.

In this case, in some arrangements, the provider computing system 104 allows the merchant to provide additional options to entice the user to remain as a customer of the merchant in lieu of cancelling or suspending the subscription (or membership). For example, the merchant system 106 may configure the provider computing system 104 (e.g., via API or the like) to present various options to the user via the user device 102, for example, to allow the provider computing system 104 to change or modify a subscription plan on the user's behalf in lieu of cancelling or temporarily suspending the subscription. For example, the merchant may configure the provider computing system 104 to present other plan options, promotions, discounts, and/or the like, in addition to the options for cancelling or suspending the subscription. Accordingly, in some arrangements, the merchant may be encouraged to provide the configuration information by enabling the merchant to configure the provider computing system 104 to present, in addition to the options for cancelling and/or suspending the subscription, other options in an attempt to retain the user as a customer.

Still referring to FIG. 1, the user device 102, the provider computing system 104, and the merchant system 106 are connected to each other via a communication network 112. The communication network 112 is any suitable Local Area Network (LAN) or Wide Area Network (WAN). For example, the communication network 112 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS), Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combinations thereof, and/or the like. The communication network 112 is structured to permit the exchange of data, values, instructions, messages, and the like among the user device 102, the provider computing system 104, and the merchant system 106.

FIG. 2A is a diagram of an example of the user device 102 of the system 100 set forth in FIG. 1, according to some arrangements. FIG. 2B is a diagram of an example of the provider computing system 104 of the system 100 set forth in FIG. 1, according to some arrangements. Referring to FIGS. 1 through 2B, a user (customer or authorized account user) 101 operates or otherwise interacts with the user device 102. The user 101 may be any suitable entity (e.g., an individual, a company, or the like). The user device 102 may be any suitable computing device (e.g., a desktop computer, laptop, tablet, smart phone, mobile phone, gaming platform, or the like). In other arrangements, the user device 102 may be any suitable Internet of Things (IoT) device capable of data communications. For example, in some arrangements, the IoT device may be a sensor, a smart book (e.g., eBooks), a smart watch, a smart speaker, and/or the like.

In some arrangements, the user device 102 includes a processing circuit 202 having a processor 204 and memory 206. The processor 204 can be implemented with a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 206 can be implemented with a Random Access Memory (RAM), Read-Only Memory (ROM), Non-volatile RAM (NVRAM), Flash Memory, hard disk storage, and other suitable electronic storage. The memory 206 stores data and/or computer code for facilitating the various processes described herein. The memory 206 stores instructions or programming logic that, when executed by the processor 204, controls the operations of the user device 102. Moreover, the memory 206 is or includes tangible, non-transient volatile memory or non-volatile memory. Accordingly, the memory 206 includes database components, object code components, script components, or any other type of information structure for supporting the various activities and information structures described herein.

The user device 102 is shown to include various circuits and logic for implementing the activities described herein. For example, the user device 102 includes one or more of the processing circuit 202, network interface 208, input circuit 210, output circuit 212, a banking client application 214, and/or the like. While various circuits, interfaces, and logic with particular functionality are shown, it should be understood that the user device 102 includes any number of circuits, interfaces, and logic for facilitating the functions described herein. For example, one or more of the multiple circuits may be omitted, the activities of the multiple circuits may combined as a single circuit and implemented on a same processing circuit (e.g., the processing circuit 202), or additional circuits with additional functionality may be further included.

The network interface 208 is configured for and structured to establish a communication session via the communication network 112 with the provider computing system 104. The network interface 208 may include any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like.

The input circuit 210 is configured to receive user input from the user 101. The output circuit 212 is configured to output information in the form of graphics, sound, tactile feedback (e.g., vibrations), and/or the like. In this regard, the input circuit 210 and the output circuit 212 are structured to exchange data, communications, instructions, and/or the like with an input/output component of the user device 102. Accordingly, in some arrangements, the input circuit 210 and the output circuit 212 can be combined into an input/output circuit that includes or is connected to an input/output device such as, but not limited to, a display device, touchscreen, keyboard, microphone, and/or the like. In some arrangements, the input/output circuit includes communication circuitry for facilitating the exchange of data, values, messages, and/or the like between the input/output device and the components of the user device 102. In some arrangements, the input circuit 210 and the output circuit 212 include machine-readable media for facilitating the exchange of information between the input/output device and the components of the user device 102. In still other arrangements, the input circuit 210 and the output circuit 212 may include any combination of hardware components (e.g., a touchscreen), communication circuitry, and machine-readable media.

The banking client application 214 may be a server-based application executable on the user device 102. In this regard, the user 101 may download the banking client application 214 prior to usage, or the banking client application 214 may be pre-installed (e.g., by a manufacturer, distributor, service provider, or the like) on the user device 102. In another arrangement, the banking client application 214 is coded into the memory 206 of the user device 110. In still another arrangement, the banking client application 214 is a web-based interface application. In this case, the user 101 logs onto or otherwise accesses the web-based interface. In this regard, the banking client application 214 may be supported by a separate computing system comprising one or more servers, processors, network interface modules, and/or the like, that transmit the application for use to the user device 102. In an arrangement, the banking client application 214 includes an API and/or a Software Development Kit (SDK) that facilitate integration of other applications. All such variations and combinations are intended to fall within the spirit and scope of the present disclosure.

The banking client application 214 is communicably coupled to the provider computing system 104 (e.g., the account database 240) via the communication network 112, and is structured to permit management of at least one account of the user 101 via the banking client application 214. In this regard, the banking client application 214 provides indicative displays (or dashboards) of account information such as, but not limited to, current account balances, pending transactions, profile information (e.g., contact information), rewards associated with the account, bill pay information, and/or the like. In some examples, a bill pay option is provided by the banking client application 214, where the bill pay option allows the user 101 to pay bills in response to user input. Further, in some arrangements, the banking client application 214 is configured to process payments from the user 101 to a designated beneficiary (e.g., a merchant). For example, a user may initiate via the banking client application 214 a transfer or payment (e.g., a wire transfer, ACH transfer, and/or the like) from an account (e.g., checking or savings) associated with the user 101 to an account associated with the designated beneficiary. The account associated with the designated beneficiary may be established with the same provider institution 103 or a different provider institution.

Thus, in some arrangements, the user 101 may pay bills (e.g., credit card, mortgage, and the like), view balances, pay merchants, and otherwise manage accounts via the banking client application 214. Accordingly, the banking client application 214 includes an account information circuit 216. The account information circuit 216 is linked or otherwise connected to one or more accounts (as stored in the account database 240) associated with the user 101, and permit management of the associated accounts (e.g., transfer balances between accounts, view payment history, and the like) by communicating with the provider computing system 104. In some arrangements, the account information circuit 216 permits management of one or more subscription-based services provided by one or more merchants from the mobile banking client application 214.

In some arrangements, the banking client application 214 is communicably connected to one or more other applications (e.g., internet browser, email, calendar, global positioning system GPS, multi-media applications, gaming applications, merchant specific applications, and/or the like) that are installed on the user device 102. For example, in some arrangements, when the user installs or launches the banking client application 214, the banking client application 214 may request access to data generated by the one or more other applications. Accordingly, in some arrangements, the banking client application 214 may be communicably connected to one or more other applications that are installed on the user device 102 to enable actions supported by the banking client application 214. For example, in some arrangements, the banking client application 214 includes a data usage tracking circuit 218 and a location tracking circuit 220. The data usage tracking circuit 218 tracks and collects data corresponding to the user's usage of the one or more other applications on the user device 102. For example, the data usage tracking circuit 218 tracks the number of times the user launches an application, the amount of time the user spends interacting with the application, activity data generated by the application, and/or the like, and provides the tracked usage data to the provider computing system 104. Similarly, the location tracking circuit 220 tracks and collects location data (e.g., GPS positioning data) corresponding to the location of the user device 102, and provides the location data to the provider computing system 104. While FIG. 2A shows that the data usage tracking circuit 218 and the location tracking circuit 220 are components of the banking client application 214, the present disclosure is not limited thereto, and in other arrangements, at least one of the data usage tracking circuit 218 and the location tracking circuit 220 may be separate or independent from the banking client application 214 or may be omitted.

Still referring to FIGS. 1 through 2B, in some arrangements, the provider institution 103 is a financial institution or the like having at least one associated provider computing system 104. In some arrangements, the provider institution 103 provides products and services such as, but not limited to, credit card accounts, mobile wallet, checking/saving accounts, retirement accounts, mortgage accounts, loan accounts, investment accounts, and/or the like to the user (or customer) 101 via the provider computing system 104. In some arrangements, the provider computing system 104 includes a processing circuit 232 including a processor 234 and a memory device 236. The processor 234 can be implemented with a general-purpose processor, an ASIC, one or more FPGAs, a DSP, a group of processing components that are distributed over various geographic locations or housed in a single location or device, or other suitable electronic processing components. The memory 236 can be implemented with RAM, NVRAM, ROM, Flash Memory, hard disk storage, cloud storage, and other suitable electronic storage devices. The memory 236 stores data and/or computer code for facilitating at least some of the various processes described herein. The memory 236 includes tangible, non-transient volatile memory, or non-volatile memory. The memory 236 stores instructions or programming logic that, when executed by the processor 234, controls the operations of the provider computing system 104. In some arrangements, the processor 234 and the memory 236 form various processing circuits in the provider computing system 104.

The provider computing system 104 includes a network interface 238. The network interface 238 is structured for sending and receiving data over the communication network 112 (e.g., to and from the user device 102, the merchant system 106, and/or the like). Accordingly, the network interface 238 includes any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like. In some arrangements, the network interface 238 includes an API interface that enables the merchant system 106 to provide the configuration information via one or more APIs to enable the provider computing system 104 to provide options or recommended actions (e.g., cancel, suspend, and/or modify) on a subscription plan associated with the merchant to the user via the user device 102.

In some arrangements, the provider computing system 104 includes an account database 240 that stores customer profile information and account information relating to one or more accounts associated with the user 101 and other customers of the provider institution 103. The account database 240 stores transaction history data of transactions (e.g., payment transactions) made by the user 101 using one or more accounts and by other customers, for example, with the banking client application 214 and/or other suitable applications. The banking client application 214 permits payments to be sent to the merchant associated with the merchant system 106 via the user device 102. In some arrangements, the banking client application 214 permits automatic recurring payments to be scheduled, so that payments are automatically sent to the merchant associated with the merchant system 106 via the provider computing system 104 at a scheduled predetermined time period (e.g., daily, monthly, bi-monthly, quarterly, yearly, and/or the like).

In some arrangements, the provider computing system 104 includes a merchants database 242. The merchants database 242 may be an internal database with respect to the provider computing system 104 or an external database accessible by the provider computing system 104. In some arrangements, the merchants database 242 may have an internal database component and an external database component for storing data corresponding to an external database maintained by the merchant system 106. In some arrangements, the internal database component may store known or learned information corresponding to the merchant. For example, in some arrangements, the provider computing system 104 may collect and store merchant information that is learned (e.g., via data mining or machine learning) from analyzing transaction history data of one or more customers of the provider institution 103 that have transacted with the merchant via the provider computing system 104. In some arrangements, the known information corresponding to the merchant may include the configuration information (e.g., form attributes and parameters) if provided by the merchant system 106. In some arrangements, the provider computing system 104 may have an interface to pull or receive (e.g., via an API or the like) the merchant data (e.g., usage data of the merchant's customers) from the external database maintained by the merchant system 106 periodically, as needed, or desired, to collect and store the merchant data in the external database component. However, the present disclosure is not limited thereto, and in other arrangements, the external database component may be omitted so that the provider computing system 104 does not store the merchant data, and instead, pulls or otherwise receives the merchant data from the external database maintained by the merchant periodically or as needed or desired.

In some arrangements, the provider computing system 104 includes a rules database 252 for storing rules. In some arrangements, the provider computing system 104 may use the rules to determine the conditions in which to present a recommendation to the user for a particular good or service. In some arrangements, the rules may be user-defined and/or automatically generated. For example, in some arrangements, a user may define how to manage subscriptions for goods or services based on user preferences. For example, a user may define the circumstances in which the user should be alerted of a recurring payment for a good or service that violate one or more of the rules. In another example, a user may define a rule to be notified of any recurring payments each month, regardless of whether or not the goods or services are being used. In yet another example, a user may define a rule to automatically suspend payments for a subscription (or membership) when a predefined amount of disuse is detected. In still another example, a user may define a rule to automatically cancel any subscriptions having a payment due that is less than (or more than) a threshold amount when the system determines disuse of the subscription for more than a threshold time period (e.g., two months).

In some arrangements, the rules may be predefined or automatically generated by the provider computing system 104. For example, predefined rules may include default rules for any rule that the user does not specifically override with a user-defined rule. Automatically generated rules may be automatically generated to override one or more default rules based on market trends, data mining, and machine learning. In some arrangements, the rules may include exceptions (or whitelists) to one or more of the rules, in which the user defines situations in which a rule may be ignored. For example, while a general rule to notify the user when an amount of time of disuse of a good or service exceeds a particular threshold value may be defined, the user may include an exception to the rule for a particular merchant or a particular type of good or service. In another example, a user may define a rule to never cancel subscriptions relating to a particular merchant or to a particular type of good or service (e.g., mortgage payments, insurance services, and/or the like).

Upon receiving user-defined or automatically generated rules, the rules are indexed and stored in the rules database 252. A non-exhaustive list of some of the rules may include, for example, amount of time that has lapsed since last use of an identified goods or service, when to surface a reoccurring payment to the user, dollar amount range of the subscription or membership fees, expected time and date of transactions, purpose for the transactions, frequency of transactions, exceptions to the rules (e.g., whitelists), and/or the like. However, the present disclosure is not limited thereto, and the rules may include any suitable user-defined or automatically generated rules based on enriched data available or learned (e.g., via data mining or machine learning) from transactions conducted on the provider computing system 104.

Still referring to FIG. 2B, in some arrangements, the provider computing system 104 includes a usage analysis circuit 244. The usage analysis circuit 244 is operatively connected to one or more of the components of the provider computing system 104. For example, the usage analysis circuit 244 is connected to the network interface 238 for communicating with the user device 102 and/or the merchant system 106. In some arrangements, the usage analysis circuit 244 may be implemented with the processing circuit 232. For example, the usage analysis circuit 244 can be implemented as a software application stored within the memory 236 and executed by the processor 234. Accordingly, such examples can be implemented with minimal or no additional hardware costs. However, in other arrangements, the usage analysis circuit 244 may be implemented on dedicated hardware specifically configured for performing the operations of the usage analysis circuit 244 described herein.

Accordingly, in various arrangements, the usage analysis circuit 244 is communicatively connected to the account database 240, merchants database 242, rules database 252, and other databases managed by or connected to the provider computing system 104. For example, the usage analysis circuit 244 is connected to the account database 240 to access (e.g., query) the account/profile information, historical transaction information, and/or payment information stored thereon. The usage analysis circuit 244 can also gather the merchant data and/or configuration information associated with the merchant system 106 by accessing (e.g., querying) the merchants database 242 or other external merchant databases. For example, the usage analysis circuit 244 can query the other external merchant databases with suitable APIs. Further, the usage analysis circuit 244 is connected to the rules database 252 to access (e.g., query) the user-defined and/or automatically generated rules.

The usage analysis circuit 244 is configured to identify subscription-based (or membership based) goods and services associated with one or more payments from one or more of the user's accounts to provide one or more recommended actions to the user 101 based on the user's usage of the identified subscription-based goods and services. In some arrangements, the one or more recommended actions may be automatically implemented by the provider computing system 104 based on one or more predefined or user defined rules (e.g., stored in the rules database 252 or the like). In some arrangements, the one or more recommended actions may be implemented in response to user input. For example, in some arrangements, the provider computing system 104 presents the one or more recommended actions to the user 101 via the banking client application 214 installed on the user device 102, and the user 101 can interact with the banking client application 214 to provide the user input on the user device 102 to select one or more of the recommended actions.

In more detail, in some arrangements, the usage analysis circuit 244 includes a transaction analysis circuit 246, a disuse analysis circuit 248, and a recommendation circuit 250. In some arrangements, the transaction analysis circuit 246 identifies subscription-based (or membership based) goods or services that the user is paying for on a recurring basis. For example, the transaction analysis circuit 246 identifies recurring payments that have been made or that are scheduled to be made by analyzing the transaction history, payment history, scheduled payment information, and/or the like associated with one or more accounts of the user. For example, the transaction analysis circuit 246 can identify payments that have been made on a recurring basis by identifying future payments that are scheduled by the user to automatically recur for each relevant time period (e.g., daily, monthly, bi-monthly, quarterly, yearly, and/or the like). In another example, the transaction analysis circuit 246 can identify payments that have been made on a recurring basis by comparing a plurality of payments made to the same merchant, and determining if the plurality of payments are in the same or similar amount and/or at around the same or similar time period within the relevant time frame (e.g., every day, every month, the same or similar day of the month, the same or similar month of the year, and/or the like). However, the present disclosure is not limited thereto, and in other arrangements, the transaction analysis circuit 246 may identify the subscription-based or membership based goods or services based on user configuration or preferences. For example, in some arrangements, the user may configure the provider computing system 104 to track one or more subscription-based (or membership based) goods or services. In this case, the user may provide information associated with the subscription (or membership), such as a contract period, applicable early termination fees, purpose of the subscription, type of subscription, and/or the like.

In some arrangements, the disuse analysis circuit 248 determines whether each of the subscription-based or membership based goods or services identified by the transaction analysis circuit 246 is being used. In some arrangements, if the merchant system 106 provides the merchant data to the provider computing system 104, the disuse analysis circuit 248 analyzes the merchant data to determine if a corresponding good or service provided by the merchant is being used. For example, in some arrangements, the disuse analysis circuit 248 may analyze the merchant data to determine a last use date of the good or service associated with the subscription (or membership) of the user.

In some arrangements, the disuse analysis circuit 248 analyzes the usage data provided by the data usage tracking circuit 218 to infer the last use date of the good or service. For example, in some arrangements, the disuse analysis circuit 248 analyzes the usage data to determine a last time that an application associated with a good or service provided by the merchant was used or otherwise accessed on the user device 102. In another example, in some arrangements, the usage data may indicate to what extent the good or service has been used. For example, in the case where the user device 102 is an eBook, the usage data may indicate the last time that the user read a particular book and/or to what page the user has read for the particular book. In this non-limiting example, if the user has not finished or substantially finished the particular book, and the usage data indicates that a predetermined period of time has lapsed since the last time the particular book was read or that another book is being read instead, the disuse analysis circuit 248 may infer that the user is no longer interested in reading the particular book.

In some arrangements, the disuse analysis circuit 248 analyzes the usage data to determine if any of the data generated by the one or more other applications installed on the user device 102 contains information corresponding to the use of a good or service. For example, in some arrangements, the disuse analysis circuit 248 may analyze emails, text messages, calendar items, and/or the like that are stored on the user device 102 to determine if they contain any information associated with the use of a goods or service (e.g., a calendar item indicating that a block of time is reserved to visit the gym). In some arrangements, the disuse analysis circuit 248 may analyze the location data provided by the location tracking circuit 220 to infer the last use date of the good or service. For example, in some arrangements, the disuse analysis circuit 248 may determine a last time that the user device 102 (and thus, the user 101) visited a location associated with the good or service (e.g., gym location, merchant location, or the like) from the location data.

Still referring to FIG. 2B, in some arrangements, the recommendation circuit 250 generates one or more recommended actions based on available information about a corresponding merchant that is stored in the merchants database 242 for each of the goods and services identified as being disused. For example, in some arrangements, when a particular good or service is identified as being disused by the disuse analysis circuit 248, the recommendation circuit 250 accesses the merchants database 242 to determine if one or more options can be offered or performed on a subscription (or membership) associated with the disused good or service. For example, if the merchant has configured one or more options to offer the user, the recommendation circuit 250 may present the one or more options to the user 101 via the user device 102. On the other hand, if the merchant has not configured options to offer the user, the recommendation circuit 250 determines if other available information about the merchant is stored in the merchants database 242 that can be used to generate one or more options to present to the user.

For example, in the case where the merchant has configured one or more options to offer the user, the merchant may provide information (e.g., configuration information) that can be used by the recommendation circuit 250 to directly cancel and/or suspend the subscription. The recommendation circuit 250 can use the configuration information provided by the merchant to automatically (e.g., based on one or more rules stored in the rules database 252), or upon user input (e.g., at the click of a button), directly cancel and/or suspend the subscription. However, as discussed above, the merchant may be unwilling in providing such information that allows a user to easily cancel or suspend the subscription. Thus, in exchange for providing the information to directly cancel and/or suspend the subscription, the merchant may also be allowed to configure alternative options, such as, for example, providing information (e.g., configuration information) to modify the subscription plan to a lower plan level, offer an extended period to suspend the subscription, offer discounts or other incentives to remain as a customer, offer the ability to transfer or gift the subscription, offer a window of time to rejoin without having to pay an initiation fee, offer a window of time to rejoin at a lower subscription rate, and/or the like.

On the other hand, if the merchant has not provided the configuration information, the recommendation circuit 250 may use other available information about the merchant that is stored in the merchants database 242. For example, the other available information about the merchant may be learned or inferred from data retrieved from the merchant's website, transaction history data of the user or other customers transacting with the merchant, social media data, data solicited from other customers about the merchant, and/or the like. In this case, the recommendation circuit 250 may generate the one or more options to offer the user based on the other available information. For example, the recommendation circuit 250 may provide a link to a landing page on the merchant's website that provides the information needed by the user to cancel and/or suspend the subscription.

In some arrangements, the recommendation circuit 250 accesses the rules stored in the rules database 252 to determine when an issue or potential issue should be surfaced to the user, as well as what actions, if any, should be automatically performed by the recommendation circuit 250. For example, in some arrangements, the user may provide user-defined rules (e.g., threshold values, dollar amounts, amount of time of detected disuse, good or service type, merchant type, length of time that the user has maintained the subscription, and/or the like) of when and under what circumstances that the user should be notified about a potential disused good or service, when the subscription plan can be automatically cancelled or suspended, when the user should be notified before automatically cancelling or suspending a subscription plan, and/or the like.

For example, in some arrangements, the recommendation circuit 250 may provide a recommendation plan that is automatically executed unless the user intervenes. The recommendation plan may include a schedule of the automatic actions that the recommendation circuit 250 plans to take on the disused good or service. For example, the recommendation plan may be to automatically suspend the subscription for one payment period (e.g., one month) the next time a payment is due, and then to cancel the subscription plan thereafter, unless the user modifies the recommendation plan. In some arrangements, the recommendation plan may include alternative options offered by the merchant. For example, the recommendation plan may provide various subscription plan options that can reduce the periodic subscription fee payment, a window of time that the user can rejoin without having to pay an initiation fee, an option to gift the subscription to others, and/or the like, that are configurable by the merchant. In another example, the recommendation may be provided to the user in the form of an interactive element that solicits input from the user in order to execute one or more available options. For example, the interactive element may be a button, a link, a graphic, and/or the like that the user can select in order to cancel, suspend, and/or modify the subscription plan. In either case, in some arrangements, the usage analysis circuit 244 may present the recommendation (e.g., recommendation plan, interactive display, and/or the like) to the user on an interactive display via the user device 102 to allow the user to manage one or more subscription-based goods or services that are identified by the provider computing system 104 (e.g., the usage analysis circuit 244) as being disused (or not used).

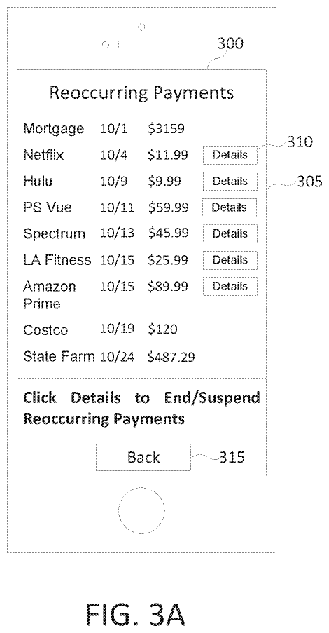

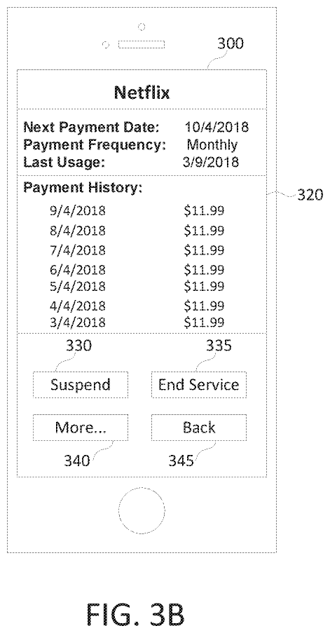

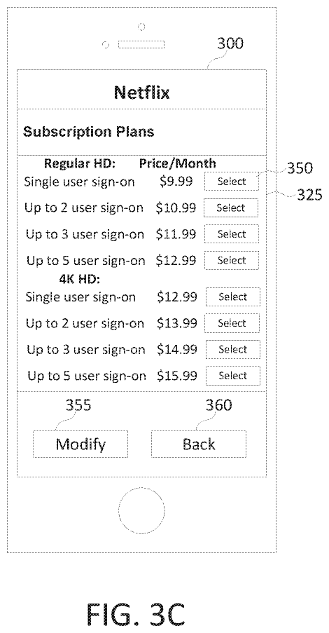

For example, FIGS. 3A through 3C show an interactive display for enabling a user to manage one or more subscription-based goods or services, according to some arrangements. In some arrangements, the provider computing system 104 presents an interactive display 300 on the user device 102. In some arrangements, the interactive display 300 enables a user to manage one or more subscription (or membership) based goods and services from various different merchants all from a single interactive display, instead of having to separately manage and track each of the subscription-based goods and services from different websites associated with different merchants. For example, in order to manage each subscription (or membership), a user is generally required to individually recall and track all of the subscriptions (or memberships), and then go to a website of an associated merchant to search for the information needed to make any changes to the subscription (or membership).

However, with the increasing popularity of subscription-based goods and services, a user may not always recall each of the subscriptions that the user has signed up for, especially for those subscriptions that offer an initial free trial that automatically converts to a paid subscription once the free trial period ends. In addition, even if the user is able to recall and track all of the subscription-based goods and services, the user is generally required to search for the information needed to make changes to the subscription through each merchant's website, which can be extremely time consuming especially if the user has various different subscriptions with various different merchants. Further, this problem is exacerbated on mobile devices with smaller screens, since the size of the screen can make it difficult for the user to find the needed information. Accordingly, the interactive display 300 allows a user to quickly identify and track each of the subscription-based goods and services from a single location, and enables the user to quickly make changes to the subscriptions without having to search for the information on various different merchant webpages.

Referring now to FIG. 3A, in some arrangements, the interactive display 300 presents a list 305 of the subscription (or membership) based goods and services identified by the usage analysis circuit 244. For example, in some arrangements, as shown in FIG. 3A, the list 305 may include each of the goods or services that the user is paying for on a recurring basis as identified by the transaction analysis circuit 246. In some arrangements, the list 305 includes interactive elements 310 that the user can select if the recommendation circuit 250 has generated one or more recommended options for the subscription (or membership) associated with a particular good or service. For example, the interactive element 310 may be a “Details” button that the user can select in order to view the recommendation for the particular goods or services. However, in other arrangements, the list may include only those goods and services identified by the transaction analysis circuit 246 that are determined to be disused by the disuse analysis circuit 248, and/or only those goods and services that have one or more recommended options generated by the recommendation circuit 250. In some arrangements, the interactive display 300 may include a back button 315 to return to a previous page. Accordingly, in some arrangements, the interactive display 300 makes it easy for a user to track all of the subscription-based goods and services that the user is making recurring payments towards, without having to scroll through each monthly statement to identify each of the recurring payments, which can be time consuming especially on a small screen.

Referring now to FIG. 3B, in some arrangements, the interactive display 300 presents a details page 320 in response to the user selecting one of the interactive elements 310 corresponding to the details button shown in FIG. 3A. For example, FIG. 3B corresponds to the details page 320 corresponding to the selection of the details button 310 for Netflix shown in the list 305 of FIG. 3A. In some arrangements, the details page 320 may display information associated with a payment to the merchant (e.g., Netflix), including a next payment date, payment frequency, last usage date (e.g., as determined by the disuse analysis circuit 248), and/or the like. In some arrangements, the details page 325 may display payment history with the date and amount of the payments made to the same merchant (e.g., Netflix). In some arrangements, the details page 325 may include one or more interactive elements 330, 335, and 340 corresponding to one or more recommended actions generated by the recommendation circuit 250, if any. In some arrangements, the details page 325 may include a back button 345 to return to a previous screen.

In some arrangements, the interactive element 330 may be selected by the user to suspend (e.g., assuming that the merchant allows the subscription to be suspended) the subscription (or membership) associated with the merchant (e.g., Netflix) of the details page 325. In this case, assuming that the merchant allows subscriptions to be suspended, when the user selects the suspend button 330, the subscription may be automatically suspended by the provider computing system 104 (e.g., in the case where the configuration information is provided by the merchant), or the user may be, for example, redirected to a landing page on the merchant's website with instructions to suspend the subscription (e.g., in the case where the merchant does not provide the configuration information). However, in the case where the merchant does not allow for a temporary suspension of the subscription (or membership), the suspend button 330 may be omitted. Similarly, in some arrangements, the interactive element 335 may be selected by the user to cancel the subscription (or membership) associated with the merchant (e.g., Netflix) of the details page 325. In this case, when the user selects the end service (or cancel) button 335, the subscription may be automatically canceled by the provider computing system 104 (e.g., in the case where the configuration information is provided by the merchant) or the user may be, for example, redirected to a landing page on the merchant's website with instructions to cancel the subscription (e.g., in the case where the merchant does not provide the configuration information). Accordingly, in some arrangements, the interactive display 300 enables the user to easily manage the subscription-based goods or services to make changes with a click of a button, instead of having to search through each individual merchant's website.

On the other hand, assuming that the merchant has configured alternative options to present to the user, in some arrangements, the interactive element 340 may be selected by the user to view more options configured by the merchant. For example, if the user selects the more button 340, the user may be directed to an alternative options page 325 that presents additional options configured by the merchant to present to the user. The alternative options page 325 shown in FIG. 3C assumes that the merchant (e.g., Netflix) has configured the provider computing system 104 to modify the subscription plan for the user. In the non-limiting arrangement shown in FIG. 3C, the alternative options page includes interactive elements 350 for selecting one of the subscription plans, a modify button 344 to modify the subscription plan according to the selected plan indicated by the select button 350, and a back button 360 to return to the previous page. In some arrangements, when the user selects one of the select buttons 350 and then selects the modify button 355, the provider computing system 104 automatically modifies the subscription plan for the user. Accordingly, in various arrangements, the merchant may be encouraged to provide the merchant data and the configuration data in order to present alternative options to the user in lieu of cancelling or suspending the subscription.

While FIGS. 3A-3C show a specific flow of the interactive display 300, the present disclosure is not limited thereto, and in other arrangements, the flow may be different, additional pages may be added, pages may be omitted, interactive elements may be rearranged, and/or the like. For example, the list 305 shown in FIG. 3A may include the interactive elements to suspend 330 and cancel 335 the subscription plan in addition to, or in lieu of, the details button 310. In another example, instead of having the more button 340 in FIG. 3B, the alternative options page may be presented to the user in response to the user selecting one of the suspend button 330 and the cancel button 335. In still another example, the modify button 355 shown in FIG. 3C may be omitted, and the subscription plan may be automatically modified in response to the user selecting one of the select button 350. Thus, various flows and interactive elements may be variously changed in the interactive display 300, all without departing from the spirit or scope of the present disclosure.

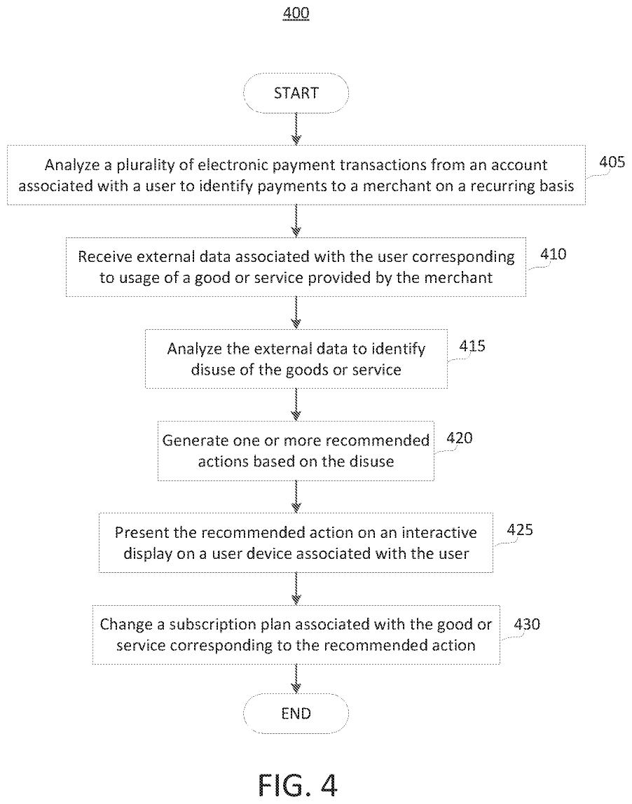

Referring now to FIG. 4, a process of managing a subscription-based good or service based on disuse is shown, according to some arrangements. The process starts and electronic payment transactions from an account associated with the user is analyzed at block 405 to identify payments to a merchant on a recurring basis. For example, in some arrangements, the transaction analysis circuit 246 can identify payments that have been made on a recurring basis by identifying future payments that are scheduled by the user to automatically recur for each relevant payment period (e.g., daily, monthly, bi-monthly, quarterly, yearly, and/or the like). In another example, the transaction analysis circuit 246 can identify payments that have been made on a recurring basis by comparing a plurality of payments made to the same merchant, and determining if the plurality of payments are in the same or similar amount and/or at around the same or similar period within the relevant payment period (e.g., every day, every month, the same or similar day of the month, the same or similar month of the year, and/or the like).

External data associated with the user is received at block 410, the external data corresponding to the usage of a good or service of the merchant. For example, in some arrangements, the merchant provides (e.g., via API) usage data corresponding to the use of the good or service associated with the user's subscription with the merchant. In another example, in some arrangements, the external data is generated by the user device, and received from the user device. In some arrangements, the external data generated by the user device includes user data generated by one or more applications installed on the user device corresponding to the user's usage of the one or more applications. In some arrangements, the one or more applications include a merchant application associated with the good or service provided by the merchant, and the user data generated by the merchant application is included in the external data. In some arrangements, the one or more applications include a location tracking application, and the external data includes the user data generated by the location tracking application corresponding to a position of the user device at any given time. In some arrangements, the one or more applications include a calendar application, and the external data corresponds to the user data generated by the calendar application. In some arrangements, the one or more applications include an email application, and the external data corresponds to the user data generated by the email application.

The external data is analyzed at block 415 to identify disuse of the good or service. For example, in some arrangements, if the merchant system 106 provides the merchant data to the provider computing system 104, the disuse analysis circuit 248 analyzes the merchant data to determine if a corresponding good or service provided by the merchant is being used. In another example, in some arrangements, the disuse analysis circuit 248 analyzes the usage data provided by the data usage tracking circuit 218 or the location tracking circuit 220 (e.g., corresponding to the positioning information) to infer the last use date of the good or service. In still another example, in some arrangements, the disuse analysis circuit 248 may analyze emails, text messages, calendar items, and/or the like that are stored on the user device 102 to determine if they contain any information associated with the use of the good or service.

In response to identifying disuse of the good or service, one or more recommended actions are generated at block 420 based on the disuse. For example, in some arrangements, the recommendation circuit 250 accesses the merchants database 242 to determine if one or more options can be offered or performed on a subscription (or membership) associated with the disused good or service. For example, in some arrangements, the recommendation circuit 250 can use the configuration information provided by the merchant to automatically (e.g., based on one or more rules stored in the rules database 252), or upon user input (e.g., at the click of a button), directly cancel and/or suspend the subscription. In another example, in some arrangements, the recommendation circuit 250 may generate the recommendations based on alternative options configured by the merchant to modify the subscription plan to a lower plan level, offer an extended period to suspend the subscription, offer discounts or other incentives to remain as a customer, offer the ability to transfer or gift the subscription, offer a window of time to rejoin without having to pay an initiation fee, offer a window of time to rejoin at a lower subscription rate, and/or the like. In still another example, in some arrangements, the recommendation circuit 250 may provide a link to a landing page on the merchant's website that provides the information needed by the user to cancel and/or suspend the subscription.

The recommended actions are presented on an interactive display on a user device associated with the user at block 425. In some arrangements, the interactive display 300 enables a user to manage one or more subscription (or membership) based goods and services from various different merchants all from a single interactive display, instead of having to separately manage and track each of the subscription-based goods and services from different websites associated with different merchants. In some arrangements, the interactive display displays a recommendation plan that is automatically executed at a predetermined time unless the user intervenes before the predetermined time lapses. In some arrangements, the interactive display includes an interactive element that solicits input from the user in order to execute one or more available options. For example, the interactive element may be a button, a link, a graphic, and/or the like that the user can select in order to cancel, suspend, and/or modify the subscription plan.

The subscription plan associated with the good or service is changed at block 430 corresponding to the recommended action, and the process ends. For example, in some arrangements, the recommended action may be automatically executed by the provider computing system 104 according to one or more user-defined or automatically generated rules stored in the rules database 252. In another example, the recommended action may be automatically executed by the provider computing system 104 according to user input corresponding to the user's selection of one of the interactive elements.

Accordingly, in various arrangements of the present disclosure, a user may be presented various subscription-based goods and services that appear to be disused but that the user is continuously making payments towards to allow for the efficient management of the subscription-based goods and services from a single location and at a click of a button. Thus, funds that are allocated to the payment of subscription-based goods and services that are not used can be redirected as desired, resulting in decrease in spending waste.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web arrangements of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims, and their equivalents.

1. A computing system comprising:
one or more processors; and
one or more computer-readable storage media communicatively coupled to the one or more processors and having instructions stored thereon that, when executed by the one or more processors, cause the one or more processors to:
analyze a plurality of electronic payment transactions from an account associated with a user to identify payments to a merchant on a recurring basis;
receive external data associated with the user corresponding to usage of a good or service provided by the merchant, wherein the external data corresponds to user data and is generated by a user device, the user device including one or more applications installed thereon that generate the user data corresponding to the user's usage of the one or more applications different from an application used to perform the plurality of electronic payment transactions;
analyze the external data to identify disuse of the good or service;
generate a recommended action based on the disuse;
present the recommended action on an interactive display on [[a]]the user device associated with the user; and
change a subscription associated with the good or service corresponding to the recommended action.

2. The system of claim 1, wherein the external data is further provided by a merchant system associated with the merchant via an application programming interface API.

3. The system of claim 1, wherein the external data corresponding to the user data comprises at least one of a number of times the user launched a particular application, an amount of time the user interacted with the particular application, activity data generated by the particular application, and global position system (GPS) positioning data.

4. The system of claim 1, wherein the external data corresponding to the user data is further generated by a data usage tracking circuit of the user device or a location tracking circuit of the user device.

5. The system of claim 1, wherein the one or more applications include a merchant application associated with the good or service provided by the merchant, and the external data corresponds to the user data generated by the merchant application.

6. The system of claim 1, wherein the one or more applications include a location tracking application, and the external data corresponds to the user data generated by the location tracking application.

7. The system of claim 1, wherein the one or more applications include a calendar application or an email application, and the external data corresponds to the user data generated by the calendar application or the email application.

8. The system of claim 1, wherein the recommended action includes at least one of cancelling, suspending, or modifying the subscription associated with the good or service.

9. The system of claim 8, wherein the interactive display presents one or more interactive elements on the user device to cancel, suspend, or modify the subscription associated with the good or service, and the subscription is changed in response to the user selecting one of the one or more interactive elements.

10. The system of claim 8, wherein the subscription is changed automatically based on one or more rules associated with the user's preferences stored in a rules database.

11. A method comprising:
analyzing, by one or more processors of a computing system, a plurality of electronic payment transactions from an account associated with a user to identify payments to a merchant on a recurring basis;
receiving, by the one or more processors, external data associated with the user corresponding to usage of a good or service provided by the merchant, wherein the external data corresponds to user data and is generated by a user device, the user device including one or more applications installed thereon that generate the user data corresponding to the user's usage of the one or more applications different from an application used to perform the plurality of electronic payment transactions;
analyzing, by the one or more processors, the external data to identify disuse of the good or service;
generating, by the one or more processors, a recommended action based on the disuse;
presenting, by the one or more processors, the recommended action on an interactive display on the user device associated with the user; and
changing, by the one or more processors, a subscription associated with the good or service corresponding to the recommended action.

12. The method of claim 11, further comprising:
querying, by the one or more processors, a merchant system associated with the merchant via an application programming interface API; and
receiving, by the one or more processors, the external data from the merchant system.

13. The method of claim 11, wherein the external data corresponding to user data comprises at least one of a number of times the user launched a particular application, an amount of time the user interacted with the particular application, activity data generated by the particular application, and global position system (GPS) positioning data.

14. The method of claim 11, wherein the external data corresponding to the user data is further generated by a data usage tracking circuit of the user device or a location tracking circuit of the user device.

15. The method of claim 11, wherein the one or more applications include a merchant application associated with the good or service provided by the merchant, and the external data corresponds to the user data generated by the merchant application.

16. The method of claim 11, wherein the one or more applications include a location tracking application, and the external data corresponds to the user data generated by the location tracking application.

17. The method of claim 11, wherein the one or more applications include a calendar application or an email application, and the external data corresponds to the user data generated by the calendar application or the email application.

18. The method of claim 11, wherein the recommended action includes at least one of cancelling, suspending, or modifying the subscription associated with the good or service.

19. The method of claim 18, further comprising:
presenting, by the one or more processors, one or more interactive elements on the interactive display on the user device to cancel, suspend, or modify the subscription associated with the good or service; and
receiving, by the one or more processors, user input corresponding to a selection of one of the one or more interactive elements,
wherein the subscription is changed in response to receiving the selection.

20. A non-transitory computer-readable medium having processor-readable instructions stored thereon such that, when executed by a processor, cause the processor to:
analyze a plurality of electronic payment transactions from an account associated with a user to identify payments to a merchant on a recurring basis;
receive external data associated with the user corresponding to usage of a good or service provided by the merchant, wherein the external data corresponds to user data and is generated by a user device, the user device including one or more applications installed thereon that generate the user data corresponding to the user's usage of the one or more applications different from an application used to perform the plurality of electronic payment transactions;
analyze the external data to identify disuse of the good or service;
generate a recommended action based on the disuse;
present the recommended action on an interactive display on [[a]]the user device associated with the user, the interactive display including one or more interactive elements to cancel, suspend, or modify a subscription associated with the good or service;
receive user input corresponding to a selection of one of the one or more interactive elements; and
change the subscription associated with the good or service in response to the user input.
